(19) United States
(12) Patent Application Publication
(10) Pub. No.: US 2015/0147563 A1
(43) Pub. Date: May 28, 2015

(54) AIR CONDITIONING LAMINATE AND METHOD

(71) Applicants: Ronald STANIS, Des Plaines, IL (US); Qinbai FAN, Chicago, IL (US)

(72) Inventors: Ronald STANIS, Des Plaines, IL (US); Qinbai FAN, Chicago, IL (US)

(21) Appl. No.: 14/091,761

(22) Filed: Nov. 27, 2013

(51) Int. Cl. C09D 129/04; F24F 5/00; C08K 3/36

(52) U.S. Cl. CPC C09D 129/04; C08K 3/36; F24F 5/0035
USPC 428/312.8; 427/385.5; 427/388.1; 427/372.2; 427/387; 428/319.3; 428/319.1

(57) ABSTRACT

A method of improving the vertical wicking properties of an inert foam substrate used in air conditioning units includes the step of coating the inert foam substrate with a hydrophilic material. The hydrophilic material can be a zeolite, a superabsorbent polymer, or a composite or combination thereof. An inert foam laminate for vertical wicking of a liquid is also provided.

### FIELD OF THE INVENTION

This invention is directed to a method of improving the wicking properties of an inert foam substrate. This invention is also directed to a foam laminate for vertical wicking of a liquid.

### BACKGROUND OF THE INVENTION

Inert foams are desired for use in humidification and dehumidification applications in the air conditioning industry. In order to be useful, the inert foam should have good air transport and good corrosion resistance as well as good water transport properties. Known inert foams include metal foams made of titanium or nickel, and polyolefin foams made of polypropylene or polyethylene. While these foams can offer good air transport and resistance to corrosion, they are hydrophobic and do not readily absorb or transport water. Moreover, these foams will not wick water vertically. For these reasons, these inert foams have not been ideal for many air conditioning applications.

There is a need or desire in the air conditioning industry for an inert foam that has, in combination, good corrosion resistance and good air and water transport properties.

### SUMMARY OF THE INVENTION

The present invention is directed to a method of improving the wicking properties of an inert foam substrate used in air conditioning units. The method includes the step of coating the inert foam substrate with a hydrophilic material selected from the group consisting of superabsorbent polymers, zeolites, and composites and combinations thereof. Prior to coating, the inert foam substrate already has good corrosion resistance and good air transport properties. The hydrophilic coating provides the inert foam substrate with good water transport and vertical wicking properties, making it particularly suitable for air conditioning applications.

The present invention is also directed to an inert loam laminate for vertical wicking of liquid. The inert foam laminate comprises an inert hydrophobic foam substrate and a hydrophilic coating disposed on the substrate. The inert hydrophobic foam substrate includes at least one of a polyolefin foam and an inert metal foam. The hydrophilic coating includes at least one of a superabsorbent polymer and a zeolite.

With the foregoing in mind, it is a feature and advantage of the invention to provide an inert foam laminate for air conditioning units that offers combined properties of good corrosion resistance, good air transport, and vertical wicking and transport of water. These and other features and advantages will become further apparent from the following detailed description of the invention, read in conjunction with the drawings.

### BRIEF DESCRIPTION OF THE DRAWINGS

FIG. 1 is a side view of an inert foam laminate of the invention for the vertical wicking of liquid.

FIG. 2 schematically illustrates an air conditioning unit that embodies the inert foam laminate for vertical wicking of liquid, according to the invention.

FIG. 3 is a graph showing the water wicking performances of an uncoated (control) titanium foam and zeolite-coated foams, as a function of time, as described in the Examples.

### DETAILED DESCRIPTION OF THE INVENTION

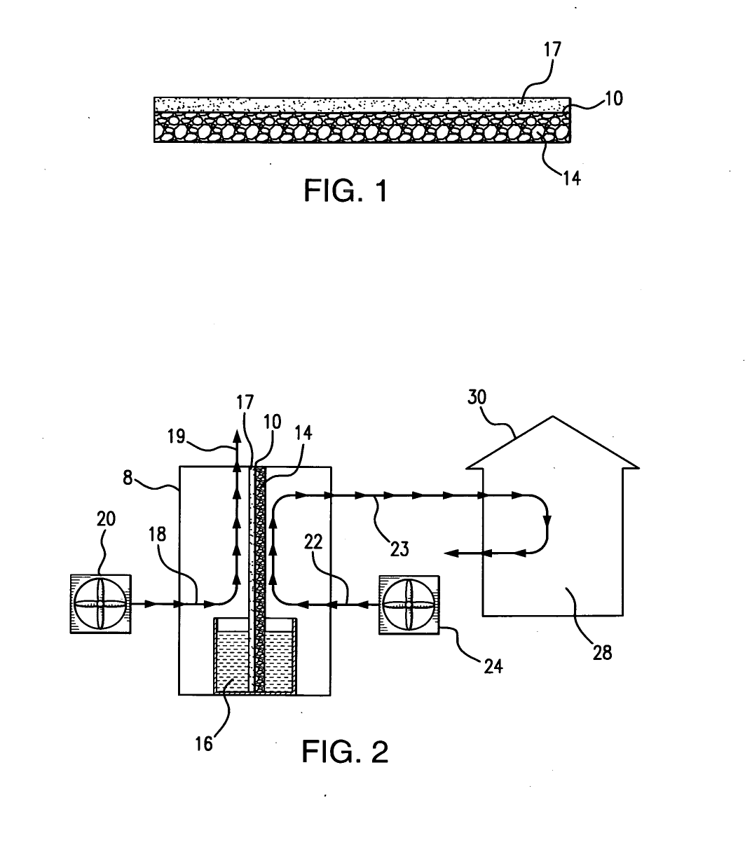

This invention is directed to a method of improving the wicking properties of an inert foam substrate used in air conditioning units. Referring to FIG. 1, an inert foam laminate 10 includes an inert foam substrate 14 intended for use in air conditioning units. The inert foam substrate 14 can be any suitable inert foam material that is corrosion-resistant and is open-celled, enabling the transport and passage of air. The inert foam substrate 14 is typically hydrophobic. Suitable inert foam materials include without limitation inert open-celled metal foams, including titanium and nickel foams, and inert open-celled polyolefin foams, including polypropylene and polyethylene foams. The inert foam substrate 14 can have a thickness of about 50 microns to about 1 millimeter, suitably about 100 to about 500 microns. The length and width of the inert foam substrate 14 and of the inert foam laminate 10 can vary depending on the size and capacity of the air conditioning unit.

A hydrophilic material layer 17 is coated onto the inert foam substrate 14 to form the inert foam laminate 10. The hydrophilic material imparts water passage and vertical wicking properties to the inert foam laminate 10, so that the inert foam laminate 10 has good corrosion resistance as well as good air transport, water transport and vertical wicking. The hydrophilic material layer 17 is formed of a material selected from superabsorbent polymers, zeolites, and composites and combinations thereof.

Superabsorbent polymers are polymers that can absorb very large amounts of water relative to their own mass. Superabsorbent polymers can absorb water in an amount from about 40 to about 800 times their own weight, commonly from about 100 to about 500 times their own weight. The superabsorbent polymer can be selected from natural, synthetic, and modified natural polymers. Examples of natural and modified natural superabsorbent polymers include without limitation hydrolyzed acrylonitrile-grafted starch, acrylic acid grafted starch, methyl cellulose, chitosan, carboxymethyl cellulose, hydroxypropyl cellulose, and natural gums such as alginates, xantham gum, locust bean gum and the like. Examples of synthetic superabsorbent polymers include without limitation alkali metal and ammonium salts of polyacrylic acid, polymethacrylic acid, polyacrylamides, polyvinyl ethers, hydrolyzed maleic anhydride copolymers with vinyl ethers and alpha olefins, polyvinyl pyrrolidone, polyvinyl morpholinone, polyvinyl alcohol or basic or chloride and hydroxide salts of polyvinyl amine, polyquaternary ammonium polyamine, hydrolyzed polyamide, and mixtures and copolymers thereof. These superabsorbent polymers can be crosslinked or partially crosslinked to optimize their wicking properties, or their contribution to the wicking properties of the hydrophilic material layer 17.

Zeolites are microporous aluminosilicate materials having a porous structure that can accommodate a wide variety of cations. Examples of mineral zeolites include analcime, chabazite, clinoptilolite, heuldanite, natrolite, phillipsite, and stilbite. Zeolites have ion exchange properties that help eliminate odors, bacteria and other unwanted substances from the air conditioner water used for evaporative cooling.

The superabsorbent polymers and zeolites can be used alone or separately to form the hydrophilic material layer 17. Zeolites can be mixed or otherwise combined with superabsorbent polymers to form composites having both the highly absorbent properties of a superabsorbent polymer and the absorbent and ion exchange properties of a zeolite. For example, zeolites can be combined with any of the foregoing synthetic superabsorbent polymers, suitably during synthesis and/or crosslinking of the superabsorbent polymer, using known methods.

The hydrophilic material layer 17 can have a dry thickness of about 5 microns to about 500 microns, suitably about 20 to about 100 microns, and can have a dry basis weight of about 10 mg/cm², suitably about 0.5 to about 5 mg/cm². The hydrophilic material layer 17 can be applied to the inert foam substrate 14 by forming a solution containing the hydrophilic material and applying the solution to the inert foam substrate 14 by dipping, soaking, brush coating, spray coating or the like. While a variety of solvents may be employed, water, isopropyl alcohol and combinations of them have been found to be suitable. Water and isopropyl alcohol in ratios of about 30-70 parts by weight water to about 30-70 parts by weight isopropyl alcohol have been found suitable, with a ratio of 67 parts by weight water to 33 parts by weight isopropyl alcohol being particularly suitable. The inert foam laminate 10 can then be heat treated to dry the hydrophilic material layer 17 and increase its durability towards wet/dry cycling. The heat treatment can be accomplished by any suitable means including oven baking or hot rolling, suitably at temperatures of about 100 to about 150° C., or about 105 to about 120° C.

The hydrophilic material layer 17 can include a superabsorbent polymer, a zeolite, or a composite or other combination of both. The superabsorbent polymer, whether or not combined with a zeolite, can be crosslinked or partially crosslinked to optimize its contribution to the wicking and water transport properties of the hydrophilic material layer 17. Crosslinking can be accomplished using a suitable crosslinking agent, and can occur before or after (suitably after) the superabsorbent polymer is applied to the inert foam substrate 14. A wide variety of know crosslinking agents may be employed, including without limitation methylene bisacrylamides; monofunctional aldehydes; 1,4-butanedioldiacrylate; ammonium persulfate; polyols; functionalized polyvinyl alcohols; alkylene carbonates; oxazolidone compounds, and the like. Crosslinking can be initiated using heat, radiation, and other known techniques. In one embodiment, the crosslinking is performed by heat treating the superabsorbent-coated inert foam substrate 14 at 80° C. in an oven for one hour, followed by pressing the superabsorbent-coated inert foam substrate 14 at 80° C. for 5 min and 10,000 psi, using the crosslinking agent. The amount of crosslinking agent may vary, and can range from about 2% to about 40% based on the weight of the superabsorbent polymer, suitably about 10% to about 30% based on the weight of the superabsorbent polymer.

When the hydrophilic material layer 17 includes a zeolite, the zeolite can first be mixed with the polymer binder to form a composition. The composition can then be applied to the inert foam substrate 14 using any suitable technique. The binder, which can be polyvinyl alcohol or another suitable polymer, is applied in a solution with the zeolite and other ingredients until several coats are achieved. One suitable zeolite composition including 20 parts by weight zeolite, 4 parts by weight polyvinyl alcohol binder, and 4 parts by weight colloidal silica per 100 parts by weight water. This composition can be applied using a wash coating technique such as dipping, soaking, spraying, brush coating or the like.

After each coating is applied, the laminate can be baked in an oven at 80° C. for one hour to dry and cure the binder before the next coat is applied. The number of coatings can range from about 2 to about 20, suitably about 2 to about 8. The polyvinyl alcohol acts as a temporary binder between coats. When all the coatings have been applied, the laminate can be placed into a furnace for sintering at about 200 to about 700° C., suitably about 250 to about 500° C. The sintering burns off the polymer binder while causing the colloidal silica to fuse together and act as a permanent binder. The resulting inert foam laminate 10 has durable vertical wicking and water transport properties as well as corrosion resistance and air transport properties.

FIG. 2 schematically illustrates an air conditioning unit 8 that utilizes the inert foam laminate 10 of the invention. The inert foam substrate 10 is suspended vertically in the air conditioning unit 8 with its lower portion immersed in a water basin 16. The hydrophilic material layer 17 vertically wicks water from the water basin 16 until the water is spread across the hydrophilic material layer 17. A stream 18 of warm dry air from a source 20, which can include a fan or other blower, is caused to flow across the exposed surface of the hydrophilic material layer 17 and accumulates moisture by evaporation before exiting the air conditioning unit as exhaust stream 19. The evaporation of water from the hydrophilic material layer 17 causes evaporative cooling of the entire inert foam laminate 10, including the hydrophobic inert foam substrate 14.

A second stream 22 of warm dry air from a source 20, which can include a fan or other blower, is caused to flow across the exposed surface of the inert foam substrate 14. The stream 22 is cooled as it passes across the inert foam substrate 14, resulting in a stream 23 of cooled dry air. The stream 23 of cooled dry air is transported to an internal space 28 of building 30, and is used to cool the internal space 28.

### Examples

Titanium metal foam sheets from Advanced Materials having a thickness of 10 mil, a basis weight of 72 mg/cm², and a length and width of 4.5 and 1.5 inches, were coated with a zeolite/superabsorbent polymer composite sold by ACS Material under the trade name Zeolite SAPO34. The coatings were applied using wash coating, by immersing the titanium metal foams for one minute in a solution containing 20 grams of Zeolite SAPO34, 4 grams of polyvinyl alcohol, and 4 grams of colloidal silica for every 100 grams of water. After each coating, the samples were baked in an oven at 80° C. for 30 minutes to cure the polyvinyl alcohol, which acted as a temporary binder between coats.

Sample A (control) was not wash coated but was heat treated. Samples B and C were wash coated with one coat but the coatings were not good, and these samples were not evaluated further. Samples D and E received two coats, samples F and G received four coats, and samples H and I received eight coats.

After the wash coating was completed, the 4.5×1.5 inch samples were cut into three equal 1.5×1.5 inch squares, which were sublabeled 1, 2 and 3. Samples 1 were sintered at 250° C., samples 2 were sintered at 350° C., and samples 3 were sintered at 500° C. The sintering burned off the polyvinyl alcohol and fused the colloidal silica to serve as a permanent binder.

Table 1 summarizes the number of coats, the coating basis weight, and the sintering temperature for each sample. The relationship between the number of wash coats and the zeolite loading on the titanium foam was approximately linear.

TABLE 1
Zeolite coated titanium foam samples and treatments

| | No. of | mg Zeolite/ | Sintering |
|---|---|---|---|
| Sample | coats | cm² | Temp (° C.) |
| Control | 0 | 0 | None |
| A1 | 0 | 0 | 250 |
| A2 | 0 | 0 | 350 |
| A3 | 0 | 0 | 500 |
| D1 | 2 | 2.0 | 250 |
| D2 | 2 | 1.8 | 350 |
| D3 | 2 | 1.7 | 500 |
| E1 | 2 | 1.4 | 250 |
| E2 | 2 | 1.3 | 350 |
| E3 | 2 | 1.4 | 500 |
| F1 | 4 | 3.1 | 250 |
| F2 | 4 | 2.8 | 350 |
| F3 | 4 | 2.7 | 500 |
| G1 | 4 | 3.5 | 250 |
| G2 | 4 | 3.4 | 350 |
| G3 | 4 | 3.4 | 500 |
| H1 | 8 | 5.8 | 250 |
| H2 | 8 | 5.3 | 350 |
| H3 | 8 | 5.0 | 500 |
| I1 | 8 | 5.5 | 250 |
| I2 | 8 | 5.3 | 350 |
| I3 | 8 | 5.1 | 500 |

The samples were then tested for water uptake and water wicking. For water uptake measurements, the samples were weighed, dipped in water for 10 seconds, and weighed again to determine the difference between wet and dry weights. For water wicking measurements, the samples were hung vertically with a lower end of each sample immersed in 1 cm of water. The observed height of water wicking up the samples was recorded over time.

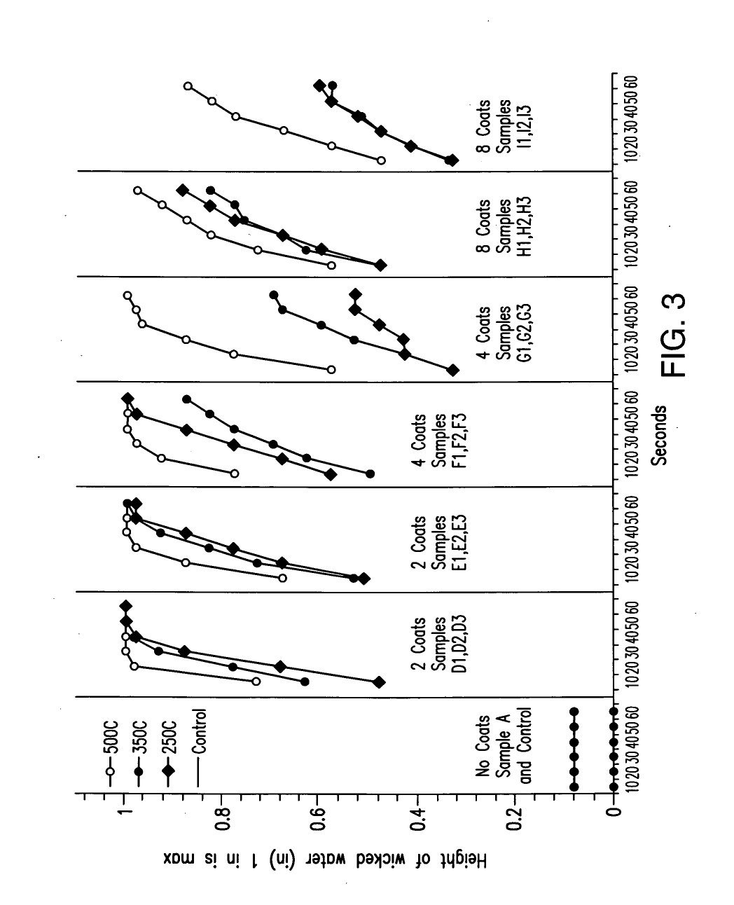

FIG. 3 is a graph showing the vertical wicking height as a function of sintering temperature for the different coating levels. In all cases, sintering at 500° C. resulted in better vertical wicking than sintering at 250° C. or 350° C. However the vertical wicking did not increase at higher coating levels. The vertical wicking maximized at two coats for each sintering temperature and showed little or no improvement or declined at higher coating levels.

The embodiments of the invention described herein are presently preferred. Various modifications and improvements can be made without departing from the spirit and scope of the invention. The scope of the invention is indicated by the appended claims, and all changes that fall within the meaning and range of equivalents are intended to be embraced therein.

We claim:

1. A method of improving the wicking properties of an inert foam substrate, comprising the step of coating the inert foam substrate with a hydrophilic material selected from the group consisting of superabsorbent polymers, zeolites, and composites and combinations thereof.

2. The method of claim 1, wherein the substrate comprises polyolefin foam selected from the group consisting of polypropylene, polyethylene and combinations thereof.

3. The method of claim 2, wherein the hydrophilic material comprises a superabsorbent polymer.

4. The method of claim 1, wherein the inert foam substrate comprises inert metal foam selected from the group consisting of titanium foam, nickel foam, and combinations thereof.

5. The method of claim 4, wherein the hydrophilic material comprises a zeolite.

6. The method of claim 5, wherein the zeolite is in the form of a zeolite-superabsorbent polymer composite.

7. The method of claim 5, further comprising the step of temporarily binding the zeolite to the metal foam using a polymer binder.

8. The method of claim 7, further comprising the step of permanently binding the zeolite to the metal foam using fused colloidal silica.

9. The method of claim 7, further comprising the steps of applying a solution coating of the polymer binder, colloidal silica and zeolite to the metal foam, heating the coated metal foam to cure the polymer binder, and sintering the coated metal foam to fuse the colloidal silica.

10. The method of claim 9, further comprising the step of applying two to eight of the coatings.

11. The method of claim 9, wherein the solution coating comprises about 10-30 parts by weight zeolite, about 1-10 parts by weight binder polymer, and about 1-10 parts by weight colloidal silica per 100 parts by weight water.

12. An inert foam laminate for vertical wicking of liquid, comprising:
an inert hydrophobic foam substrate; and
a hydrophilic coating disposed on the substrate;
wherein the inert hydrophobic foam substrate comprises at least one of a polyolefin foam and an inert metal foam; and
the hydrophilic coating comprises at least one of a superabsorbent polymer and a zeolite.

13. The laminate of claim 12, wherein the substrate comprises polypropylene or polyethylene foam.

14. The laminate of claim 13, wherein the hydrophilic coating comprises a superabsorbent polymer.

15. The laminate of claim 12, wherein the substrate comprises titanium or nickel foam.

16. The laminate of claim 15, wherein the hydrophilic coating comprises a zeolite.

17. The laminate of claim 16, wherein the hydrophilic coating comprises a combination of zeolite and superabsorbent polymer.

18. The laminate of claim 16, wherein the zeolite is selected from the group consisting of analcime, chabazite, clinoptilolite, heuldanite, natrolite, phillipsite, stilbite and combinations thereof.

19. The laminate of claim 14, wherein the superabsorbent polymer is selected from the group consisting of hydrolyzed acrylonitrile-grafted starch; acrylic acid-grafted starch; methyl cellulose; chitosan; carboxymethyl cellulose; hydroxypropyl cellulose; natural gums; alkali metal and ammonium salts of polyacrylic acid; polymethacrylic acid, polyacrylamides and polyvinyl ethers; hydrolyzed maleic anhydride copolymers with vinyl ethers and alpha-olefins; polyvinyl pyrrolidone; polyvinyl morpholinone; polyvinyl alcohol; chloride and hydroxide salts of polyvinyl amine; polyquaternary ammonium polyamine; hydrolyzed polyamide; and combinations of the foregoing, and with each other and with zeolites.

20. The laminate of claim 17, wherein the superabsorbent polymer is selected from the group consisting of hydrolyzed acrylonitrile-grafted starch; acrylic acid-grafted starch; methyl cellulose; chitosan; carboxymethyl cellulose; hydroxypropyl cellulose; natural gums; alkali metal and ammonium salts of polyacrylic acid; polymethacrylic acid, polyacrylamides and polyvinyl ethers; hydrolyzed maleic anhydride copolymers with vinyl ethers and alpha-olefins; polyvinyl pyrrolidone; polyvinyl morpholinone; polyvinyl alcohol; chloride and hydroxide salts of polyvinyl amine; polyquaternary ammonium polyamine; hydrolyzed polyamide; and combinations of the foregoing.

21. An inert foam air conditioning laminate for vertical wicking of a liquid, comprising:
a hydrophobic substrate comprising titanium foam; and
a hydrophilic coating comprising a zeolite.

22. An air conditioner comprising the inert foam laminate of claim 21.
